(19) United States
(12) Patent Application Publication
(10) Pub. No.: US 2025/0077823 A1
(43) Pub. Date: Mar. 6, 2025

(54) APPARATUS FOR GENERATING PRINT DATA, STORAGE MEDIUM, AND GENERATION METHOD

(71) Applicant: CANON KABUSHIKI KAISHA, Tokyo (JP)

(72) Inventor: MITSUO KIMURA, Kanagawa (JP)

(21) Appl. No.: 18/818,020

(22) Filed: Aug. 28, 2024

(30) Foreign Application Priority Data
Sep. 1, 2023 (JP) 2023-141949

(51) Int. Cl. G06K 15/00; G06K 15/02; G06T 11/00; G06T 11/20

(52) U.S. Cl. CPC G06K 15/408; G06K 15/1827; G06K 15/1848; G06T 11/001; G06T 11/203; G06T 2210/62

(57) ABSTRACT

An apparatus configured to generate print data by rendering document data includes at least one memory that stores instructions, and at least one processor that executes the instructions to perform operations including, with respect to a character object included in the document data, in a case where the character object satisfies a predetermined condition, controlling to skip rendering of the character object and continue to generate the print data using an object included in the document data, the object being other than the character object.

### BACKGROUND

### Field of the Disclosure

The present disclosure relates to an apparatus for generating print data, a storage medium, and a generation method.

### Description of the Related Art

A printer control apparatus described in Japanese Examined Patent Application Publication No. H04-061784 calls for a font image corresponding to input character information from a storage unit, creates a print image using the called font image, and performs print processing. At this time, in a case where the font image corresponding to the input character information is not stored in the storage unit, the printer control apparatus stops the print processing and displays a font error.

Additionally, a printer described in Japanese Patent Application Laid-Open No. 2020-138391 makes a request to a server, in a case where a command that cannot be interpreted by the printer is included in received portable document format (PDF) data, for bitmap data (Printer Working Group (PWG) data) corresponding to the PDF data. The printer then acquires the bitmap data the printer has requested and performs print processing based on the bitmap data.

In Japanese Patent Application Laid-Open No. 2020-138391, it is assumed that the server is capable of converting print target data into bitmap data. More specifically, the server described in Japanese Patent Application Laid-Open No. 2020-138391 is to acquire a glyph of font data corresponding to a font designated to the print target data and perform rendering processing (conversion into bitmap data) using the glyph. However, in Japanese Patent Application Laid-Open No. 2020-138391, a consideration is not given of a case where the server that performs such rendering processing does not hold the glyph of the font designated to a character in the print target data. Furthermore, in Japanese Examined Patent Application Publication No. H04-061784, in a case where the font image corresponding to the input character information is not stored in the storage unit, the printer control apparatus stops the print processing and displays the font error no matter what kind of print target data it is.

### SUMMARY

Embodiments of the present disclosure are directed to a technique of, even if a glyph designated to a character included in document data as a print target cannot be acquired, skipping rendering on the character to continue print processing in a case where the character does not affect a print result.

According to embodiments of the present disclosure, an apparatus configured to generate print data by rendering document data includes at least one memory that stores instructions, and at least one processor that executes the instructions to perform operations including, with respect to a character object included in the document data, in a case where the character object satisfies a predetermined condition, controlling to skip rendering of the character object and continue to generate the print data using an object included in the document data, the object being other than the character object.

Further features of the present disclosure will become apparent from the following description of exemplary embodiments with reference to the attached drawings.

### BRIEF DESCRIPTION OF THE DRAWINGS

FIG. 1 is a diagram illustrating an overall configuration of a system that provides a print service.

FIGS. 2A and 2B are diagrams each illustrating an example of a hardware configuration.

FIGS. 3A to 3C are diagrams each illustrating an example of a software configuration.

FIG. 4 is a diagram illustrating a data configuration example of an object included in document data.

FIG. 5 is a diagram illustrating examples of a screen displayed on a mobile terminal.

FIG. 6 is a flowchart illustrating a processing flow according to a first exemplary embodiment.

FIG. 7 is a flowchart illustrating details of processing performed at the time of rendering a character.

FIG. 8 is a diagram illustrating an example of a preview screen displayed in a second exemplary embodiment.

FIG. 9 is a flowchart illustrating the processing flow according to the second exemplary embodiment.

### DESCRIPTION OF THE EMBODIMENTS

By combining the technique of Japanese Examined Patent Application Publication No. H04-061784 discussed above with the technique of Japanese Patent Application Laid-Open No. 2020-138391 discussed above, in a case where the server does not hold the glyph of the font designated to the character included in the print target data, the server stops the print processing no matter what kind of print target data it is.

As a case where the server does not hold the glyph of the character designated to the print target data, there is a case where the sever does not hold the designated font data at all. Additionally, there is also a case where a version of the font data held by the server is old and the server does not hold a glyph (character shape data) of a character newly added to the font data in a new version. Furthermore, for example, there is document data in a format called searchable PDF that enables a search by execution of character recognition processing on image data and drawing of a character string that is a character recognition result on image data in a superimposed manner as invisible characters. In searchable PDF data, a font is designated to an invisible character. However, among applications that generate searchable PDF data, there is an application that designates a special font that is not common as a font for the invisible character. The print server holds glyphs of common fonts in many cases, but does not hold a glyph of the special font.

Hence, in the case of printing searchable PDF data in which the special font is designated, the print server cannot acquire the glyph corresponding to the special font, which causes an error at the time of rendering, and stops printing.

Exemplary embodiments of the present disclosure will be described below with reference to the drawings and the like. The exemplary embodiments described below are not intended to limit the present disclosure, and not all constituent elements described in the exemplary embodiments are necessarily essential to a means for solving the issues of the present disclosure.

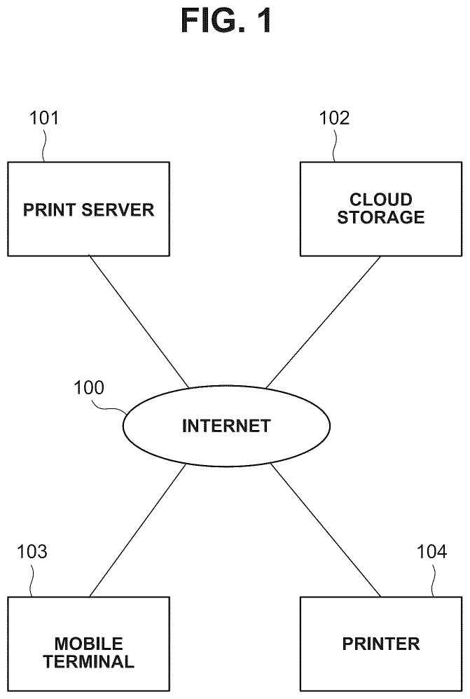

FIG. 1 is a diagram illustrating an overall configuration of a system including a print server that provides a print service according to a first exemplary embodiment. In FIG. 1, a print server 101 provides the print service for printing document data stored in a cloud storage. The print server 101 has a function of acquiring document data from the cloud storage in response to a request from a client terminal (for example, a mobile terminal 103) and generating print data from the acquired document data. Document data is stored in a cloud storage 102. The mobile terminal 103 is an example of a client terminal, and may be a smartphone, a personal computer (PC), or the like. In response to an operation by a user, the mobile terminal 103 designates document data that is a print target from among document data stored in the cloud storage 102, and requests the print server 101 to print the designated document data. A printer 104 acquires print data generated by the print server 101 and performs printing. The print server 101, the cloud storage 102, the mobile terminal 103, and the printer 104 are connected to each other via an Internet 100.

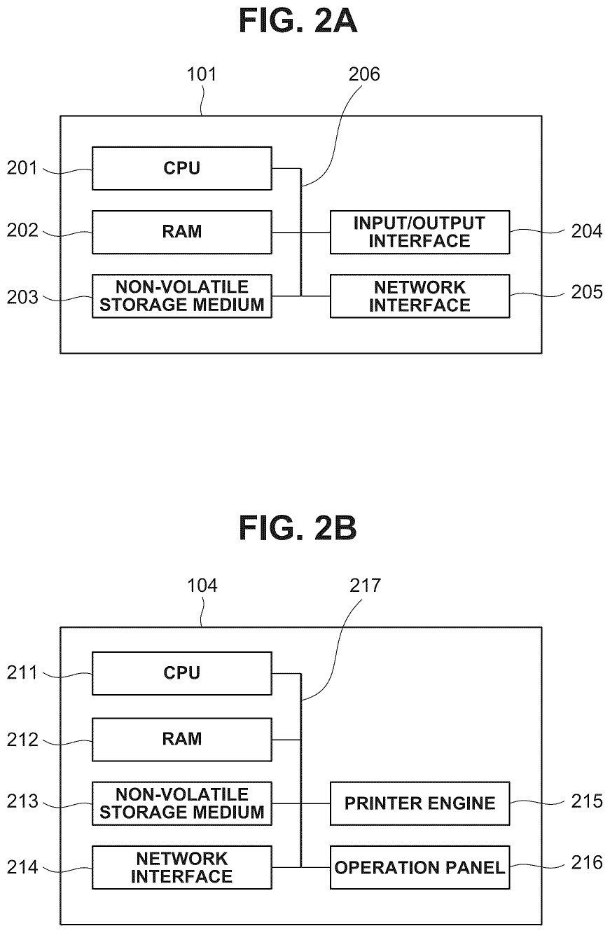

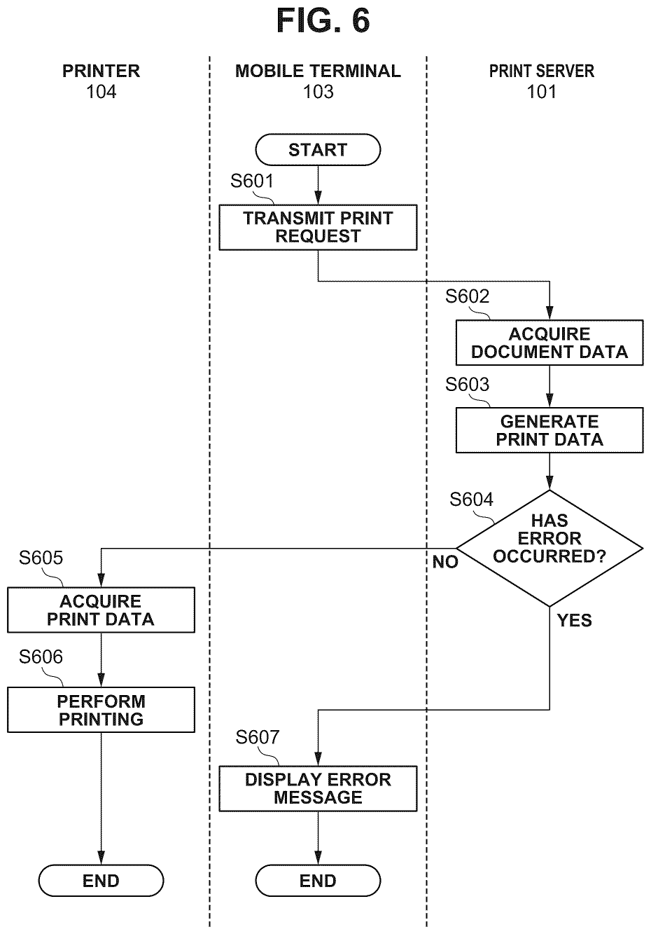

FIG. 2A is a block diagram illustrating a hardware configuration example of an apparatus capable of operating as the print server 101 or the mobile terminal 103. In FIG. 2A, a central processing unit (CPU) 201 is a unit that executes various kinds of programs and implements various functions. A random-access memory (RAM) 202 is also a unit that stores various kinds of information. Additionally, the RAM 202 is a unit that is utilized as a temporary working storage area of the CPU 201. A non-volatile storage medium 203 is a unit that stores various kinds of programs and the like, and may be, for example, a read-only memory (ROM), a flash memory, a solid-state disk (SSD), or a hard disk drive (HDD). For example, the CPU 201 loads a program (a program for a print server or a program for a mobile terminal) stored in the non-volatile storage medium 203 into the RAM 202 and executes the program. With this configuration, the CPU 201 of the print server 101 or the mobile terminal 103 functions as a processing unit that executes processing in each step of flowcharts described below with reference to FIGS. 6, 7, and 9. Implementation of the processing in each step of the flowcharts described below is not limited to implementation using the CPU 201 of the print server 101 or the mobile terminal 103, and all or part of the processing may be implemented using dedicated hardware.

An input/output interface 204 provides an interface with an output device that displays information such as a display device, an input device that accepts an instruction from the user such as a keyboard and a mouse, and an input/output device such as a touch panel. These input/output devices may be built into the mobile terminal 103 or the print server 101, or may be external units.

A network interface 205 is a unit for connecting the print server 101 and the mobile terminal 103 to a network such as the Internet 100 and an intranet (not illustrated).

The above-mentioned units 201 to 205 are configured to be capable of transmitting and receiving data via a bus 206.

Implementation of the function of the print server 101 is not limited to implementation on a single server apparatus, but may be implementation on a virtual server using could computing (namely, a cloud server).

FIG. 2B is a block diagram illustrating a hardware configuration example of the printer 104. The printer 104 includes a CPU 211, a RAM 212, a non-volatile storage medium 213, a network interface 214, a printer engine 215, and an operation panel 216, which transmit and receive data via a bus 217. The CPU 211 of the printer 104 loads a program stored in the non-volatile storage medium 213 (for example, a ROM) into the RAM 212 and executes the program to control the whole of the printer 104. For example, the CPU 211 controls, based on print data received via the network interface 214, the printer engine 215 to perform printing. The printer 104 accepts an operation from the user via the operation panel 216.

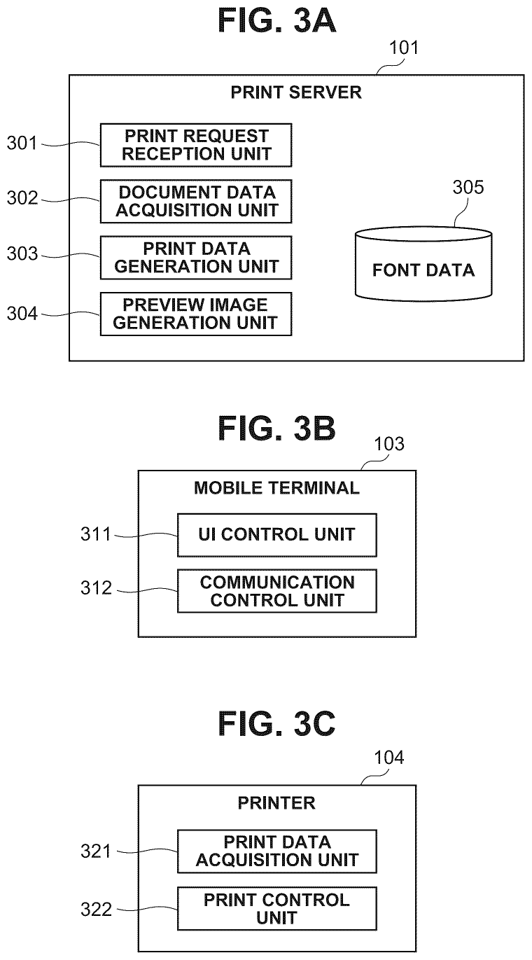

Subsequently, a description is given of a software configuration example of each of the print server 101, the mobile terminal 103, and the printer 104 with reference to FIGS. 3A, to 3C. The software configuration example indicates what function a corresponding CPU of each apparatus provides when executing a program.

FIG. 3A is a diagram illustrating the software configuration example of the print server 101. The CPU 201 of the print server 101 executes a program to function as a print request reception unit 301, a document data acquisition unit 302, a print data generation unit 303, and a preview image generation unit 304. The print request reception unit 301 accepts a print request from the mobile terminal 103 via the network interface 205. The document data acquisition unit 302 acquires document data from the cloud storage 102. The print data generation unit 303 generates print data from the document data. The preview image generation unit 304 generates image data for preview from the document data. Additionally, in the print server 101, font data 305 that is used to render a character when the print data is generated is stored in the non-volatile storage medium 203.

FIG. 3B is a diagram illustrating a software configuration example of the mobile terminal 103. The CPU 201 of the mobile terminal 103 executes a program to function as a user interface (UI) control unit 311 and a communication control unit 312. The UI control unit 311 accepts input of an operation from the user via an input/output device, such as a touch panel, and the input/output interface 204. The communication control unit 312 communicates with the print server 101 via the network interface 205.

FIG. 3C is a diagram illustrating the software configuration example of the printer 104. The CPU 211 of the printer 104 executes a program to function as a print data acquisition unit 321 and a print control unit 322. The print data acquisition unit 321 acquires the print data from the print server 101 via the network interface 214. The print control unit 322 controls the printer engine 215 to perform printing of the print data.

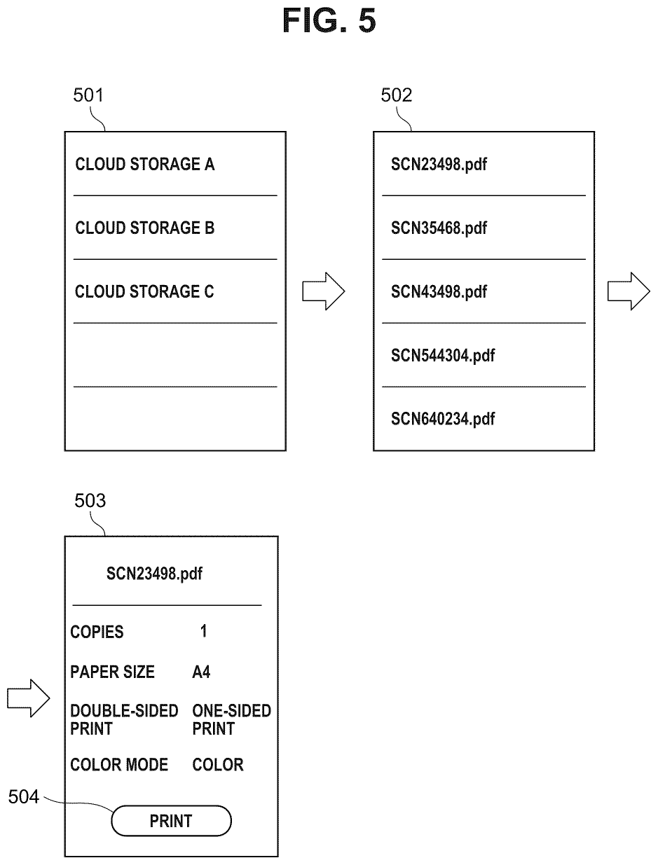

With reference to FIG. 6, a description will be given of a processing flow at the time of execution of print processing utilizing a print service provided by the print server 101 according to the present exemplary embodiment. FIG. 5 is a diagram illustrating examples of a screen displayed on the mobile terminal 103. First, a list of cloud storages that are accessible via the print server 101 is displayed on a screen 501 of the mobile terminal 103. The user selects a desired cloud storage from the list displayed on the screen 501. Subsequently, the mobile terminal 103 accesses the selected cloud storage via the print server 101 and acquires a list of document data managed by the cloud storage. Subsequently, the mobile terminal 103 displays the list of document data acquired via the print server 101 as on a screen 502. Then, when the user selects desired document data from a plurality of pieces of document data displayed in the list, the screen 502 transitions to a print setting screen 503 for making print settings (the number of copies, a paper size, selection of one-sided/double-sided printing, selection of color/monochrome printing, and the like). When the user presses a print button 504 after making various kinds of print settings, the mobile terminal 103 transmits, to the print server 101, a print request for instructing the print server 101 to print the document data selected as the print target according to the set print settings.

The processing flow in FIG. 6 is triggered by pressing of a print button 504 by the user on the print setting screen 503 displayed on the mobile terminal 103. In step S601, the communication control unit 312 of the mobile terminal 103 transmits, to the print server 101, a print request for printing the document data selected as the print target according to the print settings made by the user.

In step S602, when the print request reception unit 301 of the print server 101 receives the print request from the mobile terminal 103, the document data acquisition unit 302 acquires the document data selected by the user from the cloud storage 102 selected by the user.

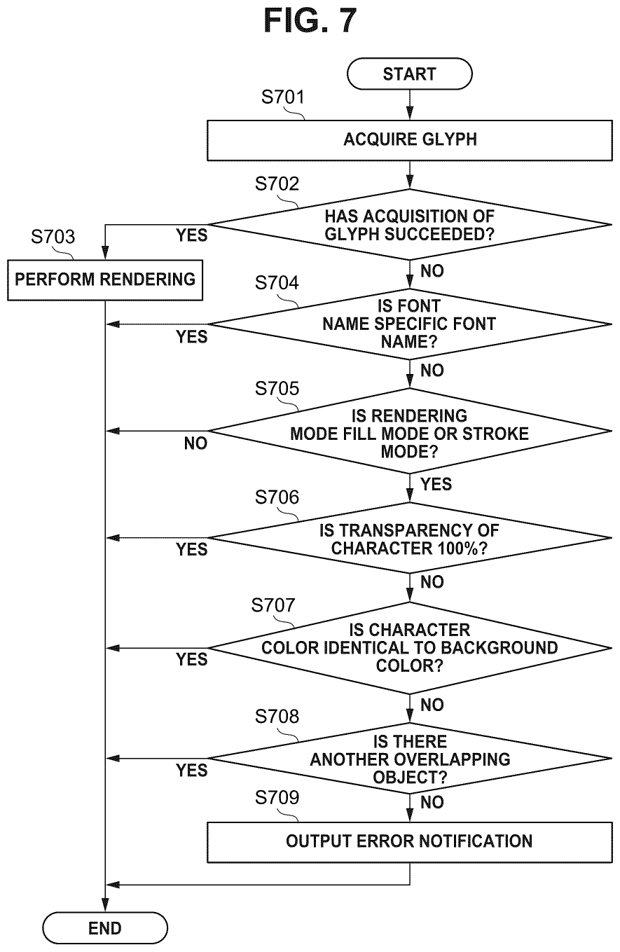

In step S603, the print data generation unit 303 of the print server 101 converts the document data acquired in step S602 to generate print data. In a case where the print server 101 fails to acquire a glyph of a common character included in the document data at the time of rendering the common character (in a case where the print server 101 does not hold the glyph and the glyph is not embedded in the document data), an error occurs. However, the print server 101 according to the present exemplary embodiment is characterized in that, in a case where a character that is a rendering target satisfies a predetermined condition, the print server 101 skips rendering on the character and is not determined as an error. Details of the processing will be described below with reference to FIG. 7.

In step S604, the print data generation unit 303 of the print server 101 determines whether an error has occurred during generation of the print data in step S603. In a case where the print data generation unit 303 determines that no error has occurred in step S604 (NO in step S604), the print server 101 holds the generated print data, and the processing proceeds to step S605.

In step S605, the print data acquisition unit 321 of the printer 104 transmits a request for acquiring the print data to the print server 101 in response to a predetermined print operation performed by the user via an operation panel of the printer 104, and acquires the print data from the print server 101. In step S606, the print control unit 322 of the printer 104 uses the acquired print data to perform printing. The present exemplary embodiment employs the configuration in which, in step S605, the printer 104 transmits, to the print server 101, the request for acquiring the print data in response to the predetermined print operation on the printer 104 to acquire the print data, but the configuration is not limited thereto. For example, in a case where a printer 104 to be an output destination is designated when print settings are made on the mobile terminal 103 and the print server 101 is in an environment where the print server 101 can transmit print data without an acquisition request from the printer 104, the print server 101 may automatically transmit print data to the printer 104.

In contrast, in a case where the print data generation unit 303 determines that the error has occurred (YES in step S604), the print data generation unit 303 of the print server 101 transmits an error notification to the mobile terminal 103, and the processing proceeds to step S607. In step S607, the UI control unit 311 of the mobile terminal 103 displays an error message on a display.

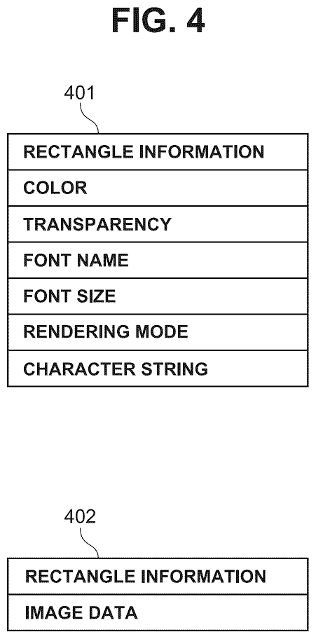

FIG. 7 illustrates a detailed flow of rendering processing performed on a character included in document data at the time of conversion of the document data into print data in step S603 in FIG. 6. The document data includes not only character objects, but also objects such as images and figures. FIG. 4 is a diagram illustrating a data configuration example of an object included in the document data. A character object 401 is a data configuration example of a character object indicating information for rendering a character. The character object 401 includes rectangle information indicating a position and a size, and information regarding a color, transparency, a font name, and a font size. The color is represented by, for example, red, green, blue (RGB) values. The transparency is represented by, for example, an a value. Additionally, the character object 401 includes a rendering mode indicating a method of rendering the character. The rendering mode includes a fill mode and a stroke mode. When the character is rendered using the glyph (character shape data) of the character, the fill mode performs rendering by filling the inside of the glyph, and the stroke mode performs rendering on only an edge (contour) of the character. In a case where the rendering mode is neither the fill mode nor the stroke mode, the character is not rendered and becomes invisible.

The character object 401 also includes information regarding a character string (character code) that is the rendering target. Additionally, an image object 402 is a data configuration example of an image object indicating information for rendering an image. The image object 402 includes rectangle information indicating a position and a size for rendering the image, and image data that is the rendering target. Additionally, the document data includes a plurality of objects in the order of rendering.

The print server 101 performs rendering on each object included in the document data in the order of rendering to convert the document data into print data. The print server 101 outputs an error notification in a case where an error occurs when performing rendering on an object, such as an image and a figure in the document data. Thus, with reference to FIG. 7, a detailed description will be given of the processing flow executed when the print server 101 performs rendering on each character object 401 in the document data.

In step S701, the print data generation unit 303 of the print server 101 acquires a font name of the character object 401 and a glyph corresponding to a font designated to each character in a character string. In a case where the glyph is embedded in the document data, the print data generation unit 303 acquires the glyph from the document data. In a case where the glyph is not embedded in the document data, the print data generation unit 303 acquires the glyph from the font data 305 held by the print server 101.

In step S702, the print data generation unit 303 determines whether acquisition of the glyph has succeeded. In a case where the print data generation unit 303 determines that the acquisition of the glyph has succeeded (YES in step S702), the processing proceeds to step S703. In step S703, the print server 101 performs rendering on the character based on the acquired glyph, and ends the rendering processing on the character object 401.

In contrast, in a case where the print data generation unit 303 determines that the acquisition of the glyph has failed (NO in step S702), the processing proceeds to step S704.

In step S704, the print data generation unit 303 determines whether the font name designated to the character object 401 is a specific font name that is used for a character for search. As described above, among applications that generate searchable PDF data, there is an application that designates a special font name as a font to be designated to a character string that is a character recognition result. The print server 101 according to the present exemplary embodiment preliminarily stores the special font name used in the searchable PDF data (document data) generated by such an application as the specific font name, and uses the specific font name for determination in step S704. Since the character object for search is embedded in the searchable PDF data as invisible data, the character object to which the specific font name is designated is an object that does not affect a print result.

Hence, in step S704, in a case where the print data generation unit 303 determines that the specific font name is designated to the character object 401 (YES in step S704), the print server 101 skips rendering on the character object 401, and the processing ends. Then, in a case where there is an unprocessed object included in the document data, the print server 101 continues to perform the rendering processing on the next object. In contrast, in step S704, in a case where the print data generation unit 303 determines that the font name designated to the character object is not the specific font name (NO in step S704), the processing proceeds to step S705.

In step S705, the print data generation unit 303 determines whether the rendering mode for the character object 401 is the fill command mode or the stroke command mode. In a case where the rendering mode is neither the fill mode nor the stroke mode (NO in step S705), the print server 101 skips rendering on the character object 401, and the processing ends. Then, in a case where there is an unprocessed object included in the document data, the print server 101 continues to perform the rendering processing on the next object. In contrast, in step S705, in a case where the print data generation unit 303 determines that the rendering mode is the fill mode or the stroke mode (YES in step S705), the processing proceeds to step S706.

In step S706, the print data generation unit 303 determines whether the transparency of the character object 401 is 100%. A character object with transparency of 100% is a character object that does not affect the print result. Hence, in a case where the print data generation unit 303 determines that the transparency is 100% (YES in step S706), the print server 101 skips rendering on the character object 401, and the processing ends. Then, in a case where there is an unprocessed object included in the document data, the print server 101 continues to perform the rendering processing on the next object. In contrast, in step S706, in a case where the print data generation unit 303 determines that the transparency is not 100% (NO in step S706), the processing proceeds to step S707.

In step S707, the print data generation unit 303 determines whether a character color of the character object 401 is identical to a background color of a background in which the character object 401 is drawn (for example, a background color of a page in which the character object 401 is drawn). The character object in a color that is identical to the background color is the character object that does not affect the print result. Hence, in step S707, in a case where the print data generation unit 303 determines that the character color is identical to the background color of the page (YES in step S707), the print server 101 skips rendering on the character object, and the processing ends. Then, in a case where there is an unprocessed object included in the document data, the print server 101 continues to perform the rendering processing on the next object. In contrast, in step S707, in a case where the print data generation unit 303 determines that the character color is not identical to the background color of the page (NO in step S707), the processing proceeds to step S708.

In step S708, the print data generation unit 303 compares rectangle information of the character object 401 with rectangle information of the image object 402, which is later in the order of rendering, and determines whether there is the image object 402 that covers the whole of a rendering range of the character object 401. In a case where there is the image object 402 that covers the whole of the rendering range of the character object 401, the character object 401 is a character object that does not affect the print result. Hence, in step S708, in a case where the print data generation unit 303 determines that there is the image object 402 that covers the whole of the rendering range (YES in step S708), the print server 101 skips rendering on the character, and the processing ends. Then, in a case where there is an unprocessed object included in the document data, the print server 101 continues to perform the rendering processing on the next object. In contrast, in step S708, in a case where the print data generation unit 303 determines that there is no image object 402 that covers the whole of the rendering range (NO in step S708), the processing proceeds to step S709. In step S709, the print server 101 outputs an error notification, and the processing ends.

In a case where the print server 101 once ends the processing of rendering on the character object 401 included in the document data after outputting an error notification (in step S709), it is determined that the error has occurred during the generation of the print data in step S604 in FIG. 6.

As described above, in a case where the acquisition of the glyph of the font designated to the character object 401 in the document data has failed, the print server 101 determines whether the character object 401 is the character object that does not affect the print result in steps S704 to S708. More specifically, even in a case where the print server 101 fails to acquire the glyph of the character object 401, if the character object 401 satisfies a predetermined condition indicating that the character object 401 does not affect the print result as described in steps S704 to S708, the print server 101 skips rendering on the character object 401. Then, the print server 101 can continue the print processing using an object other than the character object 401.

Embodiments of the present disclosure do not necessarily include all processes in steps S704 to S708 described in FIG. 7. Embodiments of the present disclosure include at least any of the processes in steps S704 to S708.

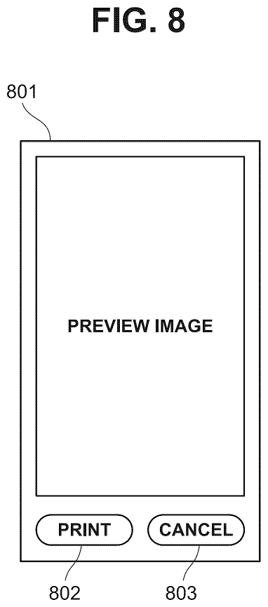

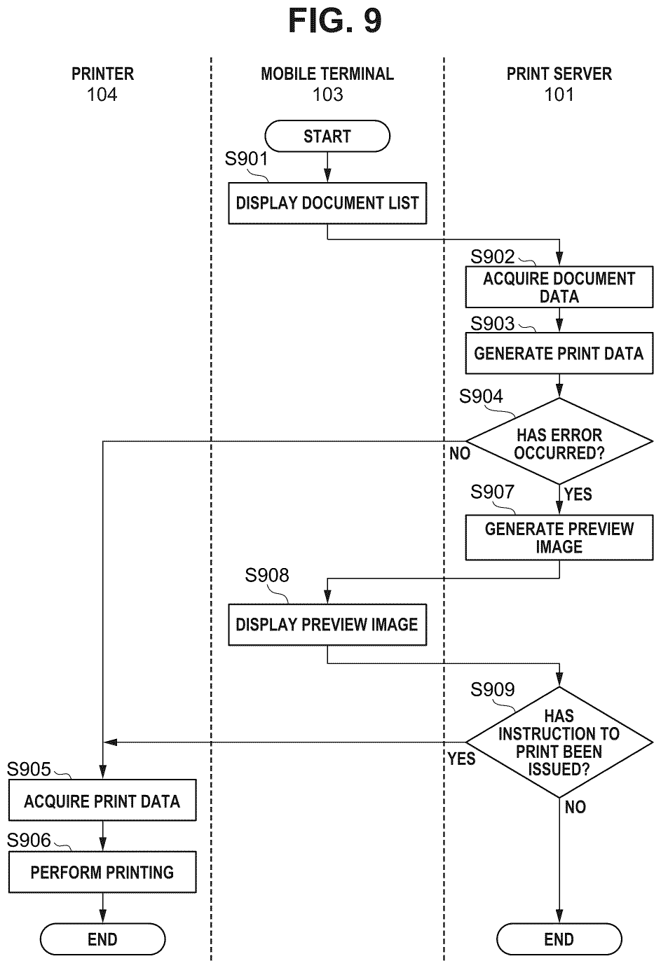

A second exemplary embodiment will be described with reference to FIGS. 8 and 9. FIG. 9 illustrates the processing flow according to the second exemplary embodiment, but only a difference from the first exemplary embodiment is described in detail here. Since steps S901 to S906 in FIG. 9 are similar to steps S601 to S606 in FIG. 6 in the first exemplary embodiment, a description thereof is omitted.

In a case where the print data generation unit 303 determines that an error has occurred in step S904 (YES in step S904), the processing proceeds to step S907. In step S907, the preview image generation unit 304 of the print server 101 generates a preview image. In the preview image, with respect to a character whose glyph cannot be acquired and that affects the print result, the character is rendered in a state where the character is garbled (.notdef glyph). The garbled character is rendered, for example, in a predetermined shape, such as a rectangle.

In step S908, the communication control unit 312 of the mobile terminal 103 receives preview image data from the print server 101, and the UI control unit 311 displays the received preview image. FIG. 8 illustrates an example of a display screen 801 for a preview image to be displayed on the mobile terminal 103. At this time, the print server 101 may give a notification about an error message indicating the presence of the character whose glyph cannot be acquired and that has been garbled, and display the error message on the display screen 801 illustrated in FIG. 8.

The user checks the preview image and presses a print button 802 or a cancel button 803. In a case where the print button 802 is pressed, a print request is transmitted to the print server 101. In a case where the cancel button 803 is pressed, a print cancel request is transmitted to the print server 101. In step S909, the print request reception unit 301 of the print server 101 determines whether the print server 101 has received the print request. In a case where the print request reception unit 301 determines that the print server 101 has received the print request (YES in step S909), the processing proceeds to step S905. In contrast, in a case where the print request reception unit 301 determines that the print server 101 has not received the print request (NO in step S909), the processing ends.

As described above, in the second exemplary embodiment, in a case where the acquisition of the glyph in the document data that is the print target has failed and the document data includes a character that affects the print result, the print server 101 generates the preview image and causes the mobile terminal 103 to display the preview image. This allows the user to check the preview image including a garbled character and give a print instruction or a print cancel instruction.

In the first and second exemplary embodiments, even in a case where the acquisition of the glyph of the character object has failed at the time of generation of the print data from the document data, the print server 101 skips rendering on the character object that does not affect the print result, as described with reference to FIG. 7. In a third exemplary embodiment, in a case where an information processing apparatus (a PC or a printer control apparatus) other than the print server 101 generates the print data from the document data, the processing as illustrated in FIG. 7 may be applied.

Embodiments of the present disclosure can also be realized by supplying a program that implements one or more functions of the exemplary embodiments described above to a system or an apparatus via a network or a storage medium, loading the program by one or more processors in a computer of the system or the apparatus, and executing the program. Furthermore, embodiments of the present disclosure can also be realized by a circuit (e.g., an application specific integrated circuit (ASIC)) that implements one or more functions.

While the description has been given of the preferable exemplary embodiments, the present disclosure is not limited to these exemplary embodiments and can be modified and changed in various manners without departing from the scope of the present disclosure.

According to embodiments of the present disclosure, even if the acquisition of a glyph designated to a character object included in document data that is a print target has failed, it is possible to print the document data in a case where a character to be rendered using the glyph does not affect a print result.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-141949, filed Sep. 1, 2023, which is hereby incorporated by reference herein in its entirety.

What is claimed is:

1. An apparatus configured to generate print data by rendering document data, the apparatus comprising:
at least one memory that stores instructions; and
at least one processor that executes the instructions to perform operations comprising:
with respect to a character object included in the document data, in a case where the character object satisfies a predetermined condition, controlling to skip rendering of the character object and continue to generate the print data using an object included in the document data, the object being other than the character object.

2. The apparatus according to claim 1, wherein the character object rendering of which is skipped is a character object to which a font is designated, the apparatus failing to acquire a glyph of the font, and the character object satisfying the predetermined condition indicating that the character object does not affect a print result.

3. The apparatus according to claim 1, wherein the predetermined condition includes a condition that a font name designated to the character object is a specific font name.

4. The apparatus according to claim 1, wherein the predetermined condition includes a condition that a rendering mode designated to the character object is neither a fill mode nor a stroke mode.

5. The apparatus according to claim 1, wherein the predetermined condition includes a condition that transparency designated to the character object is 100%.

6. The apparatus according to claim 1, wherein the predetermined condition includes a condition that a character color designated to the character object is identical to a background color.

7. The apparatus according to claim 1, wherein the predetermined condition includes a condition that there is another object superimposed on the character object.

8. The apparatus according to claim 1, wherein the apparatus performs control to skip rendering of the character object and continue to generate the print data using the object included in the document data, the object being other than the character object, in a case where at least one of a condition that a font name designated to the character object is a specific font name, a condition that a rendering mode designated to the character object is neither a fill mode nor a stroke mode, a condition that transparency designated to the character object is 100%, a condition that a character color designated to the character object is identical to a background color, and a condition that there is another object superimposed on the character object is satisfied, as the predetermined condition.

9. The apparatus according to claim 1, wherein, with respect to the character object included in the document data, in a case where the character object does not satisfy the predetermined condition, the apparatus outputs an error notification.

10. The apparatus according to claim 1, wherein, with respect to the character object included in the document data, in a case where the apparatus has failed to acquire a glyph of a font designated to the character object and the character object fails to satisfy the predetermined condition, the apparatus generates a preview image by rendering the character object in a predetermined shape.

11. The apparatus according to claim 1, wherein the apparatus is a print server.

12. The apparatus according to claim 1, wherein the apparatus is a cloud server.

13. The apparatus according to claim 1, wherein the apparatus is a control apparatus of a printer.

14. A non-transitory computer-readable storage medium storing one or more computer programs including instructions, which when executed by one or more processors of an apparatus configured to generate print data by rendering document data, cause the apparatus to perform a method comprising:
performing control to, with respect to a character object included in the document data, in a case where the character object satisfies a predetermined condition, skip rendering of the character object and continue to generate the print data using an object included in the document data, the object being other than the character object.

15. A method of generating print data by rendering document data, the method comprising:
performing control to, with respect to a character object included in the document data, in a case where the character object satisfies a predetermined condition, skip rendering of the character object and continue to generate the print data using an object included in the document data, the object being other than the character object.
